(19) United States
(12) Patent Application Publication
(10) Pub. No.: US 2010/0204836 A1
(43) Pub. Date: Aug. 12, 2010

(54) Multi-Zone Controller for Pumps

(76) Inventor: Ali Erturk, Wesley Chapel, FL (US)

Correspondence Address: TUCKER LAW OFFICES, 61 RIDGEWAY DR, BROWNSBURG, IN, 46112, US

(21) Appl. No.: 12/368,571

(22) Filed: Feb. 10, 2009

(51) Int. Cl. G05D 7/06; G05D 23/00

(52) U.S. Cl. 700/277; 700/282

(57) ABSTRACT

The present invention relates to a multi-zone controller that may be attached to and control one or more pumps. The combination of multi-zone controller with a single zone pump enables that pump to provide water cooling for multiple applications either independently or simultaneously. For example, the multi-zone controller and single zone pump may be used in conjunction with multiple normally air cooled air conditioner or refrigeration condensers, or heat exchangers, and the like for cooling indoor or outdoor areas. The combination of multi-zone controller and a single zone pump is capable of cooling all zones simultaneously. Typical zones might be one or more air conditioner condensers, heat exchangers, or the like; or one or more outdoor or indoor areas. Misting around an air conditioner condenser is normally off and is triggered only when the air conditioning unit's compressor is running. Misting of an outdoor area is activated by turning on the exterior or interior mounted electrical wall switch controlling the zone for that outdoor area, or by turning on a switch for that zone mounted on the multi-zone controller, or on a multi-zone controller/pump assembly, or by remote control.

### FIELD OF THE INVENTION

The present invention relates generally to the field of air conditioning, evaporative cooling, and heat transfer unit cooling, and particularly to a multi-zone controller for use with a high pressure pump. The multi-zone controller is configurable to control simultaneously and independently as many zones as the application and pump's flow rate and pressure allows. The use of a multi-zone controller with a single zone (single outlet) pump allows the pump to operate as a multi-zone pump.

### BACKGROUND OF THE INVENTION

It is desirable to have the ability to take a single zone high pressure pump and adapt it to work for multiple applications simultaneously. An example of this is to provide independent cooling at a facility having three separate outdoor areas where cooling of any one or a combination of any of the three areas independently is desired. The multi-zone controller will allow each of the three areas to be cooled either independently of each other, or simultaneously. Another example is an application wherein it is desired to run three A/C condensers more efficiently. In this case use of a multi-zone controller with a single zone high pressure pump would provide synchronized (with the A/C system) on demand cooling for all three condensers on an “as needed basis” versus having to purchase three pumps to provide the desired cooling effect.

No such device is known to us. The closest such known device is the “smart pump” by Cloudburst. Based on published cloudburst information the “smart pump” appears to be two pumps in a single cabinet, each pump being able to handle two zone's, that are controlled through flappers that lift up when the A/C condenser fan turns on and then engage each pump within the “smart pump” cabinet for each zone as needed. The “smart pump” appears to be limited to and configured only for condenser cooling.

### SUMMARY OF THE INVENTION

The present invention is a novel multi-zone controller that allows a single pump to function as like multiple independent pumps. The novel multi-zone controller of the present invention provides environmental benefits by reducing and maximizing power consumption so that a single pump can be used for multiple applications. Thus use of the multi-zone controller to convert a single pump for use in multiple applications independently both reduces the initial cost of the system and minimizes operating costs and environmental impact. The multi-zone controller will work with pumps in a myriad of applications and fields including, residential, commercial, agricultural, parks, marine, hydraulic, industrial, motor vehicle and aviation, and the like.

### BRIEF DESCRIPTION OF THE DRAWINGS

FIG. 1a Shows a schematic diagram of the multi-zone controller of the present invention connected to a single pump for applying a fine mist spray of water to multiple air conditioner and cooler condenser units, and to a covered outdoor patio.

FIG. 1b Shows a call out diagram of the multi-zone controller connected to a single pump.

FIG. 2 Shows a schematic diagram of one possible configuration out of many, of a 6 zone system, in which 5 zones are activated by 24 VAC relays which receive an input signal from the heat transfer units thermostatic controls; and one zone is activated by an electrical switch, in which the internal wiring, components and circuitry of the multi-zone controller are shown.

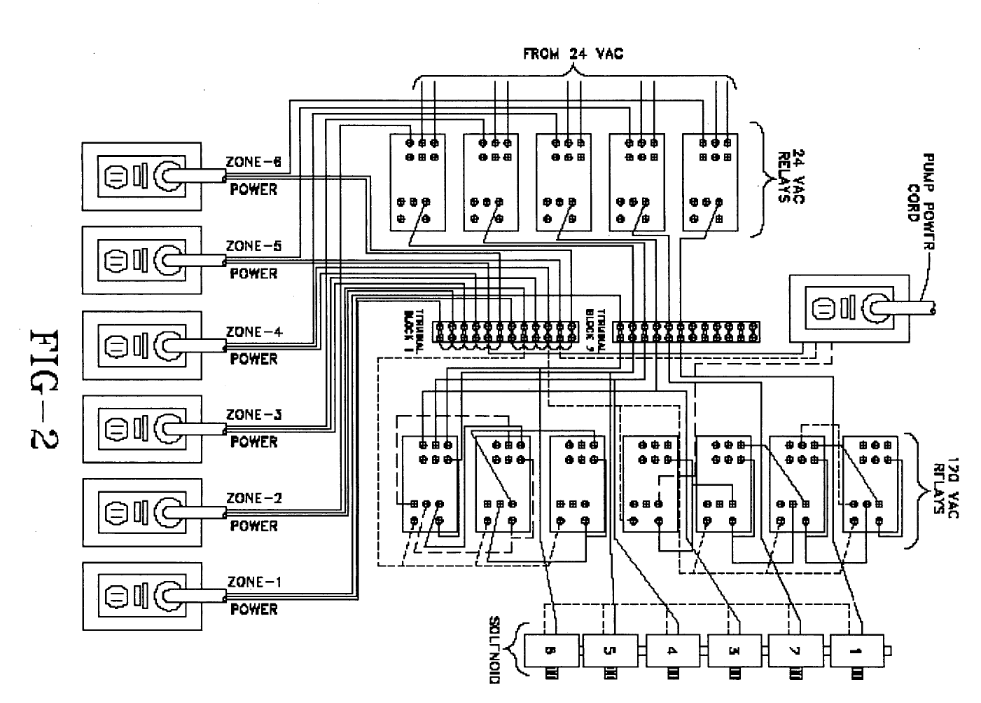

### DETAILED DESCRIPTION OF THE INVENTION

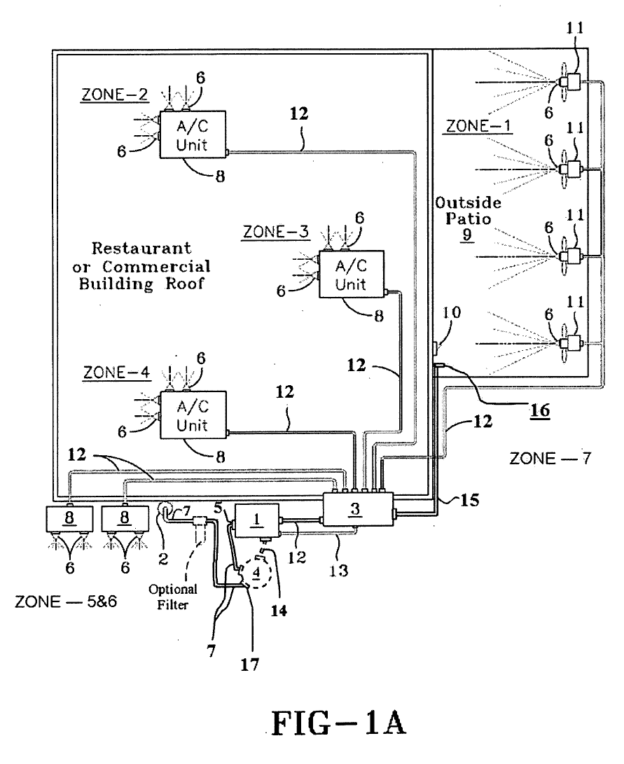

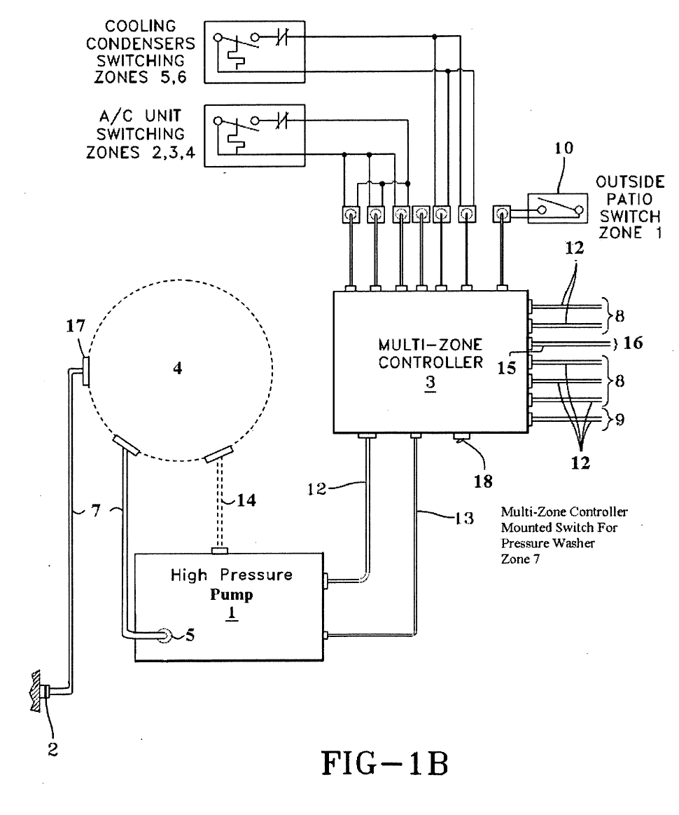

As shown in FIG. 1a, the multi-zone controller 3 can be used effectively as a component of a mist cooling system, such as that described in U.S. patent application Ser. No. ______ that also comprises a high pressure pump 1, water line 7 for delivering water from water source 2 to the high pressure pump 1, and high pressure discharge lines 12 for delivering water from the high pressure pump 1 to the multi-zone controller 3 and then to the misting nozzles 6 that spray a fine mist to cool the desired areas and/or items. In addition, the multi-zone controller 3 of the present invention also may be used effectively in other applications such as pressure washing.

The multi-zone controller 3 operates through relays, contactors, a microprocessor, or a programmable logic controller, and the like, preferably relays, to synchronize and activate the controls required to control the solenoid or valve, and the like for each zone as needed.

The multi-zone controller also may be used to control multiple pumps, and/or high pressure washing systems, and/or other applications requiring the delivery of water under pressure to multiple zones.

The use of the multi-zone controller 3 of the present invention combined with a single high pressure pump 1 allows the single high pressure pump 1 to cool multiple zones from one pump instead of requiring one pump for each zone. For example, if an application has five areas that need cooling, the multi-zone controller of the present invention would allow one high pressure pump 1 to be utilized for all five areas, and if the high pressure pump 1 had an eight amp draw all zones would be cooled with those eight amps. Current technology would require five pumps each drawing eight amps for a total of 40 amps to achieve the same effect. In addition the multi-zone controller 3 of the present invention may also be used effectively in other applications such as pressure washing, heat transfer units, marine, hydraulic, residential, commercial, industrial, agricultural, motor vehicle, motorized vessel and vehicle applications, aviation applications, park applications, rail (train) applications, and the like.

The multi-zone controller 3 can be configured to provide any number of combinations and configurations for providing independent and synchronized distribution to multiple zones, and also to operate at various voltages and cycles to accommodate local electrical standards and application configuration needs.

The multi-zone controller 1 can be configured so that each zone is switched in a myriad of different ways based on system configuration needs. For example, if two zones need to be turned on with a twenty-four volt A/C signal they can be, while another zone may need to be turned on and off at the multi-zone controller, while a third zone would be turned on and off through a wall switch, and a fourth zone turned on and off through a remote control.

The multi-zone controller 3 may be configured as a stand alone unit to convert a single high pressure pump 1 for multi-zone function, or the multi-zone controller may be integrated into a pump cabinet as an assembly with a high pressure pump. The multi-zone controller 3 also may be configured to control multiple pumps.

The multi-zone controller 3 has a metallic, plastic, wooden or the like housing, preferably plastic.

Misting around an air conditioner condenser is normally off and is activated only when the air conditioning unit's compressor is running. Since each zone of the multi-zone controller 3 is independent of the other zones and is activated either by the thermostatic controls in case of misting nozzles 6 mounted on single or multiple condensing units 8, or by wall switches 10 in the case of misting nozzles 6 and fans 11, or other air circulation method, and the like, mounted around single or multiple outdoor spaces 9, the misting nozzles 6 are separately activated to cool one or more condensing units 8 and/or one or more interior or exterior areas 9 independently as desired.

The multi-zone controller 3 may also be utilized to control a high pressure washing system, utilizing the high pressure pump 1 as described in U.S. patent application Ser. No. ______.

The multi-zone controller may be used for a myriad of applications and fields, including heat transfer unit applications, marine applications, park applications, rail (train) applications, industrial applications, hydraulic applications, motor vehicle (trucks, cars, rv's etc.) applications, aviation applications, or motorized vessel applications, and the like.

The multi-zone controller is suitable for use in residential, commercial, industrial, agricultural, park, marine, aviation, heat transfer, motor vehicle (trucks, cars, rv's etc), rail (trains), motorized vessel, and the like fields.

While the present invention has been described in terms of a general embodiment and two specific embodiments, it is recognized that a person skilled in the air conditioning, evaporative cooling, pressurized pumps, pumping systems, electrical, and mechanical arts will readily perceive many modifications and variations in the embodiments described above. Such modifications and variations are included within the scope of the present invention.

We claim:

1. A multi-zone controller that can be synchronized to work with a high pressure pump, comprising;
a. a multi-zone controller operating through relays or a microprocessor or a programmable logic controller, and the like, preferably relays; which activate solenoids or valves, and the like, preferably solenoids; to control the flow of high pressure water to the desired areas and applications; and
b. said multi-zone controller being capable of working with a single pump or multiple pumps, that can support pressure washing, outdoor cooling, indoor cooling, A/C condenser cooling, refrigeration cooling, heat transfer cooling, and the like.

2. The multi-zone controller of claim 1 wherein each zone operates independently or simultaneously with any other zone; so that any combination of pressure washing, outdoor cooling, indoor cooling, A/C condenser cooling, refrigeration cooling, heat transfer units cooling, and the like, can be synchronized.

3. The multi-zone controller of claims 1 and 2 wherein the multi-zone controller has a metallic, plastic, or wooden, and the like housing, preferably plastic.

4. The multi-zone controller of claims 1 through 3 wherein the multi-zone controller comprises relays, contactors, a microprocessor or a programmable logic controller and the like, preferably relays, to synchronize and control each zone as needed.

5. The multi-zone controller of claims 1 through 4 wherein the multi-zone controller comprises relays, contactors, a microprocessor or a programmable logic controller, and the like, preferably relays, to control the solenoids or valves for each zone as needed.

6. The multi-zone controller of claims 1 through 5 comprising solenoids, valves, and the like, preferably solenoids, to control the high pressure water flow to each zone as needed.

7. The multi-zone controller of claims 1 through 6 wherein the controller may be activated by one or more of electrical wall switches, relays, remote controls, or a switch attached to the multi-zone controller, and the like, based on system configuration needs.

8. The multi-zone controller of claims 1 through 7 wherein the multi-zone controller is custom built to address customer or application needs, and may be configured with any voltage or hertz cycle combinations to meet those needs.

9. The multi-zone controller of claims 1 through 8 wherein each zone of the multi-zone controller operates independently of the other zones so that there is no limit to the possible configurations of the multi-zone controller.

10. The multi-zone controller of claims 1 through 9 wherein each zone of the multi-zone controller can be synchronized to operate with devices that indicate a demand, such as a thermostat or thermostatic control, pressure sensor, temperature sensor, flow sensor, airflow sensor, humidity sensor, rain sensor, or other device utilized to trigger or engage the various zones, solenoids or valves of the multi-zone controller.

11. The use of the multi-zone controller of claims 1 through 10 wherein the multi-zone controller can be utilized in a myriad of fields and applications, including residential, industrial, commercial, agricultural, park, marine, aviation, motor vehicle, rail (train), motorized vessel and vehicle applications, hydraulic, heat transfer, and the like.
